(19) United States
(12) Patent Application Publication
(10) Pub. No.: US 2009/0039641 A1
(43) Pub. Date: Feb. 12, 2009

(54) Advertising Device

(75) Inventors: Murray Kirk, Toronto (CA); Grant LEITCH, Toronto (CA)

Correspondence Address: Lawrence A. Aaronson, P.C.;Lawrence A. Aaronson, 12850 Highway 9, Suite #600 PMB 338, Alpharetta, GA, 30004, US

(73) Assignee: INFORMATION PACKAGING INC., Toronto, ON (CA)

(21) Appl. No.: 12/188,395

(22) Filed: Aug. 8, 2008

Related U.S. Application Data
(60) Provisional application No. 60/935,356, filed on Aug. 9, 2007.

(51) Int. Cl. B42D 15/04

(52) U.S. Cl. 283/56

(57) ABSTRACT

An advertising device formed from an elongate, foldable one-piece blank is provided. The blank includes a first rectangular panel having a first end edge and a second end edge opposite the width of the first rectangular panel from the first end edge; a second rectangular panel having a first end edge connected to the second end edge of the first rectangular panel by a fold line, the second rectangular panel having an opening therethrough and a second end edge; a third panel having a first end edge connected to the second end edge of the second rectangular panel by a fold line, the third panel having a width that is less than the width of the second panel and a second end edge interrupted by an inlet, the third panel folded over and adhered to the second panel to correspond the inlet with a portion of the opening in the second rectangular panel; a fourth panel comprising a middle portion intermediate two elongate arm portions, a first end edge of each of the elongate arm portions connected to the second end edge of the third panel by a fold line; a fifth panel having a first end edge interrupted by an inlet, the inlet of the fifth panel corresponds to a second portion of the opening through the second rectangular panel when the fifth panel is folded over the second panel, the first end edge of the fifth panel connected to the second end edge of the fourth panel by a fold line, the fifth panel having a second end edge; a tab panel having a first end edge connected to the second end edge of the fifth panel, the tab panel folded over and adhered to the first panel. The middle portion of the fourth panel is smaller than the area between the inlets of the third and fifth panel.

### CROSS-REFERENCE TO RELATED APPLICATION

This application claims priority to U.S. patent application Ser. No. 60/935,356, filed Aug. 9, 2007, entitled “ADVERTISING DEVICE,” which is incorporated herein by reference in its entirety.

### FIELD OF THE INVENTION

The device disclosed herein relate generally to advertising devices and promotional items, more particularly to a print advertising device formed from an elongate, foldable one-piece blank.

### BACKGROUND OF THE INVENTION

Advertising devices and promotional items such as brochures and other takeaway items for carrying print and image information are well known and useful for conveying the information in an attractive and compact package. While portable print advertising devices are known, improvements are of course desired in order to provide devices that convey the information in a new and attractive ways, and to further provide simple and cost-effective means for producing such devices. It is an object to provide a novel print advertising device formed from an elongate, foldable one-piece blank

### SUMMARY OF THE INVENTION

In accordance with an aspect, there is provided an elongate, foldable, one piece blank for an advertising device, comprising:

a first rectangular panel having a first end edge and a second end edge opposite the first rectangular panel from the first end edge;

a second rectangular panel having a first end edge connected to the second end edge of the first rectangular panel by a fold line, the second rectangular panel having an opening therethrough and a second end edge;

a third panel having a first end edge connected to the second end edge of the second rectangular panel by a fold line, the third panel having a width that is less than the width of the second panel and a second end edge interrupted by an inlet, wherein the inlet corresponds to a first portion of the opening through the second rectangular panel when the third panel is folded over the second panel;

a fourth panel comprising a middle portion intermediate two elongate arm portions, a first end edge of each of the elongate arm portions connected to the second end edge of the third panel by a fold line;

a fifth panel having a first end edge interrupted by an inlet, the inlet of the fifth panel corresponds to a second portion of the opening through the second rectangular panel when the fifth panel is folded over the second panel, the first end edge of the fifth panel connected to the second end edge of the fourth panel by a fold line, the fifth panel having a second end edge;

a tab panel having a first end edge connected to the second end edge of the fifth panel;

wherein the middle portion of the fourth panel is dimensioned to pass through the inlets of the third and fifth panels when pivoted relative thereto;

wherein the third panel is adapted to be folded over and adhered to the second panel;

wherein the tab panel is adapted to be adhered to the first panel.

In accordance with another aspect, there is provided an advertising device formed from an elongate, foldable one-piece blank, the device comprising:

a first rectangular panel having a first end edge and a second end edge opposite the width of the first rectangular panel from the first end edge;

a second rectangular panel having a first end edge connected to the second end edge of the first rectangular panel by a fold line, the second rectangular panel having an opening therethrough and a second end edge;

a third panel having a first end edge connected to the second end edge of the second rectangular panel by a fold line, the third panel having a width that is less than the width of the second panel and a second end edge interrupted by an inlet, the third panel folded over and adhered to the second panel to correspond the inlet with a portion of the opening in the second rectangular panel;

a fourth panel comprising a middle portion intermediate two elongate arm portions, a first end edge of each of the elongate arm portions connected to the second end edge of the third panel by a fold line;

a fifth panel having a first end edge interrupted by an inlet, the inlet of the fifth panel corresponds to a second portion of the opening through the second rectangular panel when the fifth panel is folded over the second panel, the first end edge of the fifth panel connected to the second end edge of the fourth panel by a fold line, the fifth panel having a second end edge;

a tab panel having a first end edge connected to the second end edge of the fifth panel, the tab panel folded over and adhered to the first panel;

wherein the middle portion of the fourth panel is smaller than the area between the inlets of the third and fifth panel.

The advertising device and respective blank described herein provides a variety of print surfaces upon which to display advertising, is simple to use, easy to manufacture, and straightforward to assemble.

### BRIEF DESCRIPTION OF THE DRAWINGS

Embodiments will now be described more fully with reference to the accompanying drawings, in which:

FIG. 1 is an elevation view of an elongate, foldable, one piece blank for an advertising device;

FIG. 2 is a perspective view of the advertising device in a first position according to an embodiment; and

FIG. 3 is a perspective view of the advertising device of FIG. 2 in a second position.

### DETAILED DESCRIPTION OF THE EMBODIMENTS

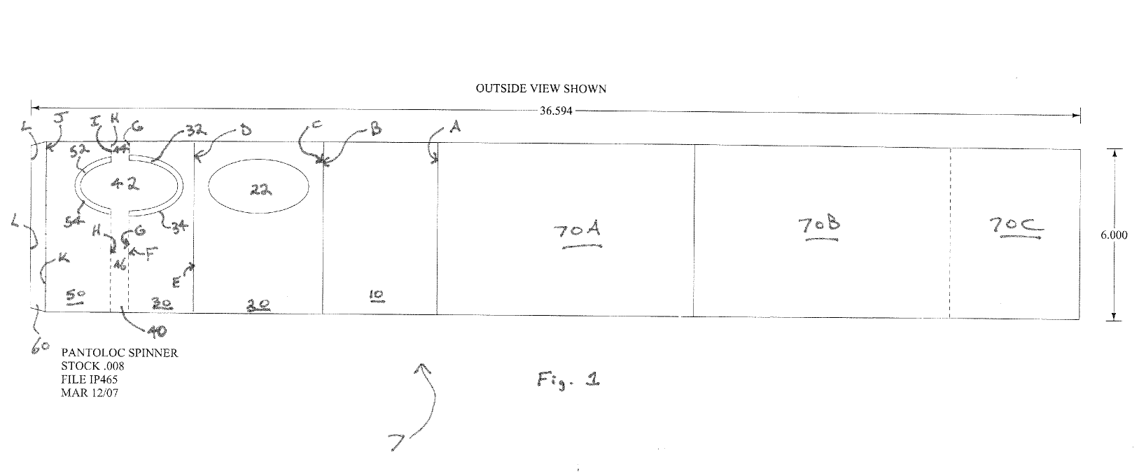

FIG. 1 is an elevation view of an elongate, foldable, one piece blank 7 for an advertising device 5. The blank 7 is formed of a single piece of card stock with interconnected panels as will be described. The interconnected panels have advertising surfaces for display of text, images, logos and other advertising or information.

Blank 7 includes a first rectangular panel 10 having a length and a width. First rectangular panel 10 has a first end edge A and a second end edge B opposite the width of first rectangular panel 20 from first end edge A. A second rectangular panel 20 is connected to the second edge B of first rectangular panel 10 at its first end edge C by a fold line. It can be seen that second rectangular panel 20 has an opening 22 between its first end edge C and a second end edge D.

Connected to second end edge D of second rectangular panel 20 at a respective first end edge E via a fold line is a third panel 30. It can be seen that third panel 30 is not as wide as second panel 20. It can also be seen that a second end edge F of third panel 30 is interrupted by an inlet 32. In this embodiment, inlet 32 is generally semicircular, and is sized such that when third panel 30 is folded over second panel 20, inlet 32 overlays a first portion of opening 22 so as to correspond with and not substantially occlude opening 22. It can be seen that inlet 32 has an inner wall 34.

A fourth panel 40 has a middle portion 42 between two elongate arm portions 44, 46. Middle portion 42 is generally oval-shaped. A first end edge G of each of elongate arm portions 44, 46 is connected to the second end edge F of third panel 30 by a crease. The crease is preferable to allow fourth panel 40 to fold easily relative to third panel 30 and to permit formation of advertising device 5 given the narrower dimensions of elongate arm portions 44, 46 and the stiffness of the card stock, but may alternatively be a standard fold line as is used between, for example, first panel 10 and second panel 20. It can be seen that middle portion 42 of fourth panel 40 is not directly connected to third panel 30, yet is dimensioned to enter into, or otherwise be received by inlet 32 of third panel 30. More particularly, when fourth panel 40 is pivoted about the crease connecting fourth panel 40 and third panel 30 relative to third panel 30, middle portion 42 of fourth panel 40 does not come into contact with third panel 30 and can therefore pass through the generally semicircular inlet 32 of third panel 30. Each of elongate arm portions 44, 46 has a second end edge H.

A fifth panel 50 has a first end edge I connected to the second end edge H of fourth panel 40 by a fold line, and a second end edge J. Similar to third panel 30, first end edge I of fifth panel 50 is interrupted by an inlet 52. According to this embodiment, inlet 52 is generally semicircular, and is sized such that when third panel is folded over second panel 20, inlet 52 overlays a second portion of opening 22 of second panel 20 so as to correspond with and not substantially occlude opening 22. It can be seen that inlet 52 has an inner wall 54 that is not connected to fourth panel 40. It can also be seen that while middle portion 42 of fourth panel 40 is not directly connected to fifth panel 50, it is dimensioned to enter into, or otherwise be received by inlet 52 of fifth panel 50. More particularly, when fourth panel 40 is pivoted about the fold/tear line connecting fourth panel 40 and fifth panel 50 relative to fifth panel 50, middle portion 42 of fourth panel 40 does not come into contact with fifth panel 50 and can therefore pass through the generally semicircular inlet 52 of fifth panel 50.

A tab panel 60 has a first end edge K connected to the second end edge J of fifth panel 50, and a second end edge L, and is adapted to be folded over and adhered to first panel 10.

It can be seen that middle portion 42 of fourth panel 42 is dimensioned to pass through inlets 32 and 52 when pivoted relative thereto, and is also sized to pass through opening 22 when third, fourth and fifth panels 30, 40 and 50 are folded over second panel 20. In order words, middle portion 42 must be able to pass through both opening 22 and inlets 32 and 52 when pivoted, whether the space between inlets 32 and 52 is larger or smaller than opening 22.

Blank 7 further includes auxiliary information panels 70A, 70B, 70C connected in series from the first end edge A of first panel 10 by a fold line as shown in the Figures. It will be understood that depending upon the requirements of the application for the advertising device 5, there may be no auxiliary information panels, one auxiliary information panels, or several. Auxiliary information panels 70B and 70C may be connected by a perforated line, or “perf” to facilitate, for example, use of auxiliary information panel 70C as a tear-away business reply card.

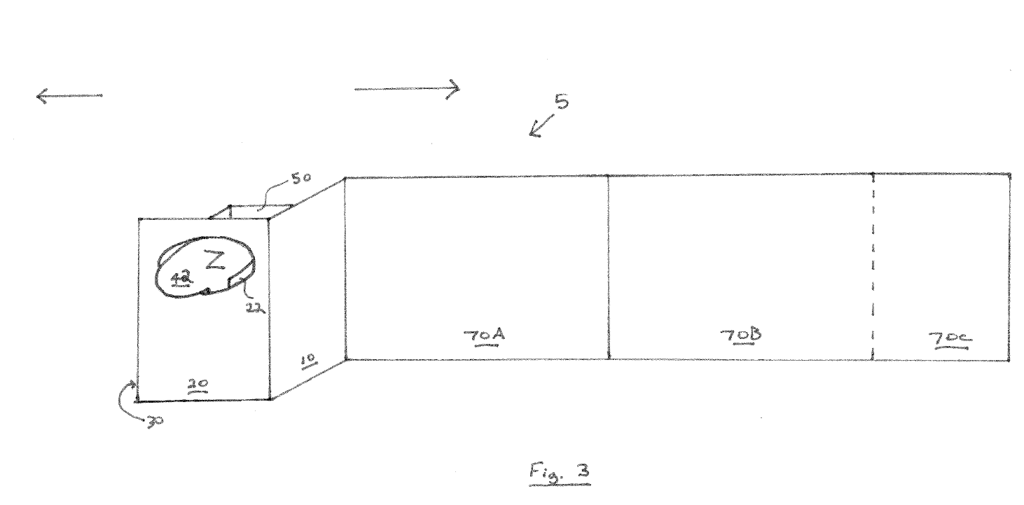

Blank 7 is formed from a printed press sheet by die cutting using an auto platten die cutter. After blank 7 has been formed, advertising device 5 is formed from blank 7. During forming of advertising device 5, the die cut blank 7 is provided to a folder/gluer machine for construction. Adhering means such as glue is applied to at least a portion of the front side (as viewable in FIG. 3) of third panel 30. Third panel 30 is then folded over and adhered to the front side of second panel 20. The adhering means is also applied to the underside of tab panel 60, which is then folded and brought into contact with the front side of first panel 10 at a location adjacent to its fold line connecting it with second panel 20. Tab panel 60 is adhered to the same side of first panel 10 as third panel. It will be understood that the overall finished size of the blank 7 will dictate the number of passes required by the folder/gluer at this stage.

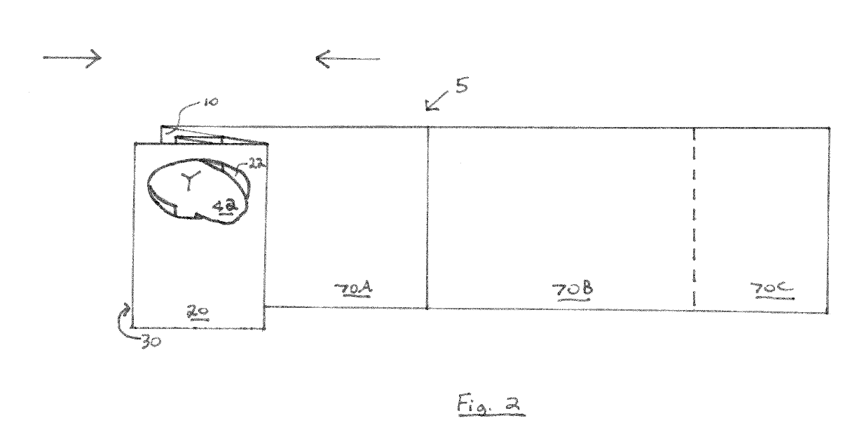

FIG. 2 is a perspective view of advertising device 5 assembled from blank 7 as described above, in a first position. FIG. 3 is a perspective view of the advertising device of FIG. 2 in a second position after having been manually “stretched” in the directions of the arrows as would be done by, for example, a user of the device. It can be seen that during the stretching, middle portion 42 of fourth panel 40 “flips” relative to second panel 20 through opening 22 and therefore after having been stretched the opposite side of middle portion 42 of fourth panel 40 shows through opening 22 that had been the case in the unstretched position. Thus has been provided a unique device that displays key information about the subject-matter being advertised, in its own pivotable panel.

While preferably the advertising device 5 and corresponding blank 7 are formed of card stock, it will be understood that other materials such as corrugate may be used. It is also conceivable that plastics of certain types may be used in more specialized applications.

Middle portion 42 of fourth panel 40 is oval-shaped as described above, but may be other shapes such as circular, triangular, square, rectangular and the like, or irregular shaped, as long as it can pass through inlets 32 and 52, and opening 22. For example, middle portion 42 may be shaped and printed as a beverage bottle, car, disco ball or whatever shape is appropriate to the advertising situation. In fact, inlets 32 and 52, and opening 22 may be of different shapes other than generally semi-circular (such as rectangular etc.) and may match to or be differently-shaped than middle portion 42.

Although embodiments have been described, those of skill in the art will appreciate that variations and modifications may be made without departing from the spirit and scope of the invention defined by the appended claims.

What is claimed is:

1. An elongate, foldable, one piece blank for an advertising device, comprising:
a first rectangular panel having a first end edge and a second end edge opposite the first rectangular panel from the first end edge;
a second rectangular panel having a first end edge connected to the second end edge of the first rectangular panel by a fold line, the second rectangular panel having an opening therethrough and a second end edge;
a third panel having a first end edge connected to the second end edge of the second rectangular panel by a fold line, the third panel having a width that is less than the width of the second panel and a second end edge interrupted by an inlet, wherein the inlet corresponds to a first portion of the opening through the second rectangular panel when the third panel is folded over the second panel;
a fourth panel comprising a middle portion intermediate two elongate arm portions, a first end edge of each of the elongate arm portions connected to the second end edge of the third panel by a fold line;
a fifth panel having a first end edge interrupted by an inlet, the inlet of the fifth panel corresponds to a second portion of the opening through the second rectangular panel when the fifth panel is folded over the second panel, the first end edge of the fifth panel connected to the second end edge of the fourth panel by a fold line, the fifth panel having a second end edge;
a tab panel having a first end edge connected to the second end edge of the fifth panel;
wherein the middle portion of the fourth panel is dimensioned to pass through the inlets of the third and fifth panels when pivoted relative thereto;
wherein the third panel is adapted to be folded over and adhered to the second panel;
wherein the tab panel is adapted to be adhered to the first panel.

2. The blank of claim 1, wherein the respective fold lines connecting the fourth panel to each of the third and fifth panels are creases.

3. The blank of claim 1, further comprising at least one an auxiliary information panel connected to the first end edge of the first panel by a fold line.

4. The blank of claim 1, wherein the panels are formed of a card stock.

5. The blank of claim 4, wherein the panels are formed of corrugate.

6. An advertising device formed from an elongate, foldable one-piece blank, the device comprising:
a first rectangular panel having a first end edge and a second end edge opposite the width of the first rectangular panel from the first end edge;
a second rectangular panel having a first end edge connected to the second end edge of the first rectangular panel by a fold line, the second rectangular panel having an opening therethrough and a second end edge;
a third panel having a first end edge connected to the second end edge of the second rectangular panel by a fold line, the third panel having a width that is less than the width of the second panel and a second end edge interrupted by an inlet, the third panel folded over and adhered to the second panel to correspond the inlet with a portion of the opening in the second rectangular panel;
a fourth panel comprising a middle portion intermediate two elongate arm portions, a first end edge of each of the elongate arm portions connected to the second end edge of the third panel by a fold line;
a fifth panel having a first end edge interrupted by an inlet, the inlet of the fifth panel corresponds to a second portion of the opening through the second rectangular panel when the fifth panel is folded over the second panel, the first end edge of the fifth panel connected to the second end edge of the fourth panel by a fold line, the fifth panel having a second end edge;
a tab panel having a first end edge connected to the second end edge of the fifth panel, the tab panel folded over and adhered to the first panel;
wherein the middle portion of the fourth panel is smaller than the area between the inlets of the third and fifth panel.

7. An elongate, foldable, one piece blank for an advertising device, comprising:
a plurality of panels each having first and second edges connected in series at respective first and second edges by a respective fold line;
the second panel in the series having an opening therethrough;
the third panel in the series having a width that is less than the width of the second panel and a second end edge interrupted by an inlet, wherein the inlet corresponds to a first portion of the opening through the second rectangular panel when the third panel is folded over the second panel;
the fourth panel in the series comprising a middle portion intermediate two elongate arm portions, only the arm portions connected to the third panel;
the fifth panel in the series having a first end edge interrupted by an inlet, the inlet of the fifth panel corresponds to a second portion of the opening through the second rectangular panel when the fifth panel is folded over the second panel,
the sixth panel in the series being a tab;
wherein the middle portion of the fourth panel is dimensioned to pass through the inlets of the third and fifth panels when pivoted relative thereto;
wherein the third panel is adapted to be folded over and adhered to the second panel;
wherein the tab panel is adapted to be adhered to the first panel.
